(19) United States
(12) Patent Application Publication
(10) Pub. No.: US 2025/0247821 A1
(43) Pub. Date: Jul. 31, 2025

(54) METHOD OF TRANSMITTING APERIODIC DOWNLINK SMALL DATA TRANSMISSIONS TO COMMUNICATION DEVICES CONFIGURED FOR SCHEDULED INACTIVATION OF A RECEIVER

(71) Applicant: Continental Automotive Technologies GmbH, Hannover (DE)

(72) Inventors: Reuben George Stephen, Singapore (SG); Rikin Shah, Langen (DE); David Gonzalez Gonzalez, Egelsbach (DE); Andreas Andrae, Frankfurt am Main (DE)

(73) Assignee: Continental Automotive Technologies GmbH, Hannover (DE)

(21) Appl. No.: 18/854,730

(22) PCT Filed: Apr. 4, 2023
(86) PCT No.: PCT/EP2023/058781

§ 371 Date: Oct. 7, 2024

(30) Foreign Application Priority Data
Apr. 5, 2022 (DE) 10 2022 203 380.9

(51) Int. Cl. H04W 68/00; H04W 52/02

(52) U.S. Cl. CPC H04W 68/005; H04W 52/0219

(57) ABSTRACT

A first communication apparatus of a radio access network transmits paging messages to one or more second communication apparatus in accordance with a paging scheme. The one or more second communication apparatus configure their receivers to be enabled accordingly, while remaining in an operating mode in which they are not fully connected to the first communication apparatus. Small data transmissions may be transmitted from the first to the one or more second communication apparatus after appropriately configuring the receivers of the one or more second communication apparatus to be enabled, while remaining in the operating mode in which they are not fully connected to the first communication apparatus. The required configuration information, in particular times for aperiodic transmissions and/or radio resources used for transmitting and/or the indication for the end of the aperiodic transmission, is transmitted by the first communication apparatus in a paging message.

### CROSS-REFERENCE TO RELATED APPLICATIONS

The present application is a National Stage Application under 35 U.S.C. § 371 of International Patent Application No. PCT/EP2023/058781 filed on Apr. 4, 2023, and claims priority from German Patent Application No. 10 2022 203 380.9 filed on Apr. 5, 2022, in the German Patent and Trademark Office, the disclosures of which are herein incorporated by reference in their entireties.

### TECHNICAL FIELD

The present invention relates to handling small data transmission (SDT) to user equipment (UE) in radio access networks (RAN), in particular when a receiver of the UE is in an inactive state.

### BACKGROUND

In today's connected world many devices are connected to other devices or systems through wireless connections. Such devices may include portable or mobile devices, sensors, and even motor vehicles. Typically, such devices communicate with each other through a wireless network infrastructure, also referred to as radio access network (RAN), such as the well-known 3G, 4G, 5G and future communication networks. Depending on the direction of a transmission the communication through a wireless network infrastructure is typically referred to as uplink or downlink. Uplink (UL) relates to communication from a UE to the RAN, more specifically to a base station thereof, also referred to as gNB, while downlink (DL) relates to communication from the RAN to a UE.

The UE may implement various measures for reducing energy consumption, which is of significant importance in particular in battery-powered devices. One of the energy-saving mechanisms includes periodically inactivating a radio resource, and activating it only at certain times, inter alia during an operating mode also referred to as RRC_INACTIVE. RRC_INACTIVE is an operating mode that may be selected when a UE is not actively communicating with the RAN. While a UE is in the RRC_INACTIVE operating mode, the RAN, via a gNB the UE is logically attached to, periodically contacts the UE for ascertaining its presence within the radio range and its availability for communication. These periodic checks occur during so-called paging cycles. The UE will configure the cyclic activation and deactivation of electronic components necessary for receiving transmissions in accordance with the paging cycles, as determined by the radio access network.

The paging of a UE through a gNB of a radio access network does not fully connect the UE to the radio access network. Rather, the UE remains in RRC_INACTIVE operating mode. This avoids the protocol overhead associated with establishing a full connection to a gNB, which takes time and consumes resources both at the UE and the gNB.

A gNB may transmit small amounts of data in the DL to the UE when paging the UE, i.e., during the short periods in which the UE's receiver known is to be active, which is also referred to as small data transmission (SDT). However, there may be occasions when the amount of data to be transmitted to the UE exceeds the amount of data that can be transmitted during the short periods in which the UE's receiver is active. While the SDT may be completed by splitting the data into segments and transmitting a series of segments at suitable times, waiting for the next paging cycles of the UE for completing the SDT may be impractical, and keeping a receiver in an active state until the transmission of the data is completed may counter energy saving efforts.

To reduce signalling overhead and latency, 3GPP TS 38.331 Release 17 introduced support for mobile-originated SDT in RRC inactive mode. A simplified schematic flow diagram of the SDT in this case is shown in FIG. 1. The UE, while in the RRC_INACTIVE operating mode, determines, in step 10, if it has data to transmit to the RAN. In the positive case, “yes”-branch of step 10, the UE, in step 12, will perform the RACH procedure, RACH being the abbreviation for random access channel, and the RACH procedure normally serves for connecting and synchronising the UE to the best gNB of the RAN. A small amount of data may be transmitted in the RACH procedure without transitioning from the RRC_INACTIVE operating mode to a fully connected state, i.e., RRC_CONNECTED.

Current versions of 3GPP TS 38.331 do not specify mobile-terminated small data transmission in RRC inactive mode, and any mobile-terminated data transmission will require the UE to transition into the fully connected state, i.e., RRC_CONNECTED. A simplified schematic flow diagram of such mobile-terminated data transmission is shown in FIG. 2. In step 20 the RAN determines if there is data to send to a UE in the DL while the UE is known to be in the RRC_INACTIVE operating mode. In the positive case, “yes”-branch of step 20, the gNB sends, in step 22, a paging message to the UE at the next UE's paging occasion. In step 24 the UE performs the RACH procedure to transit to the connected state, i.e., to the RRC_CONNECTED operating mode. When the UE is connected to the gNB, the gNB, in step 26, transmits the SDT to the UE. After the transmission the UE may go back to the RRC_INACTIVE operating mode, step 28. This way of RAN-to-UE SDT requires a significant signalling overhead, notably for transitioning to the RRC_CONNECTED operating mode and for going back to the RRC_INACTIVE operating mode, and exhibits significant latency, all the more so when only small amounts of data are to be transmitted like in SDT.

The significant protocol overhead in the existing solution for mobile-terminated DL data transfer is even more undesirable when a series of subsequent small data transmissions are to be transmitted to the UE in the DL. This case may occur, e.g., if there are several high-priority UEs to which small data is to be transmitted in the DL. Another occasion in which this case occurs may be when the channel to the UE is bad and the gNB segments the SDT packet to smaller ones with lower modulation and coding scheme index (MCS). While in this case a periodic transmission of the multiple segments may alleviate the problem such a strategy may not be sufficient, since it need not satisfy the latency requirement of the UE. Yet another occasion in which this case occurs may be when flexibility in the sleep/wake cycle in the RRC_INACTIVE state is required for handling high priority delivery and/or for improved reliability. In summary, there is currently no satisfying solution for transmitting UE-terminated aperiodic small data transmissions while the UE is in an operating mode in which electronic components required for receiving transmissions are periodically enabled and disabled in accordance with a scheme or schedule.

### BRIEF SUMMARY

There is, thus, a need to provide a mechanism for improved handling of aperiodic small data transmissions while a receiving communication apparatus is in an operating mode, in which electronic components required for receiving transmissions are periodically enabled and disabled in accordance with a schedule or scheme, e.g., in a UE that is in RRC_INACTIVE state.

This object is achieved by the methods and the communication apparatus specified in the independent claims. Advantageous embodiments and developments are provided in the respective dependent claims.

The invention tries to resolve situations in which it is not specified if a RAN-initiated SDT during the paging period has any effect on the UE's paging cycle, which determines when the electronic components required for receiving transmissions are enabled, without leaving the RRC_INACTIVE state. Moreover, with gNB-initiated, or DL, SDT it is unclear if the UE needs to additionally wake up or not outside the paging cycle, e.g., in case one or more subsequent DL SDT transmissions are planned.

In accordance with a first aspect of the invention a method of operating a first communication apparatus is presented, for configuring a second communication apparatus to receive aperiodic small data transmission while the second communication apparatus is in a first operating mode. In the first operating mode electronic components necessary for receiving transmissions are periodically enabled for brief time periods and disabled in between, in accordance with a schedule, scheme, or paging cycle that is configured in accordance with information received from the first communication apparatus. The expressions schedule, scheme, or paging cycle are used interchangeably throughout this specification unless different meanings are clear from the respective context. Likewise, transmissions from the first communication apparatus to the second communication apparatus occurring throughout the paging cycle or in accordance with the schedule or scheme are referred to as paging messages, irrespective of the expression used for the paging cycle, i.e., schedule or scheme, unless a different meaning is clear from the respective context.

The method in accordance with the first aspect of the invention comprises transmitting a paging message to the second communication apparatus in accordance with the paging cycle. The paging message includes or is complemented by a signal indicating properties of an impending small data transmission to the second communication apparatus.

The properties may comprise, inter alia, an indication if the impending small data transmissions are transmitted in periodic intervals, i.e., in accordance with a periodic traffic pattern, or aperiodically, i.e., not following a periodic traffic pattern. If an aperiodic small data transmission is indicated, the method further comprises transmitting, in the signal indicating properties of the impending small data transmission, in an aperiodic small signal transmission itself, or on a separate control channel, an indication permitting detection of a completion or termination of the small data transmission. In the former case the indication may comprise a number of packets or transmissions that will be sent, and/or a total amount of data that will be transmitted. In the latter two cases, e.g., in the penultimate or the ultimate packet or transmission, or on a separate control channel, the indication may comprise a last packet indication.

The signal indicating properties of an impending small data transmission to the second communication apparatus, or an aperiodic small data transmission itself, may further comprise an indication of a time at which the next aperiodic small data transmission will be sent. The time may be indicated, e.g., by a timer value for the second communication apparatus, at which the second communication apparatus is expected to have the electronic components required for receiving transmissions enabled, or that the next aperiodic small data transmission will be transmitted at the occasion of the next enabling of the electronic components required for receiving transmissions, as scheduled in the second communication apparatus, i.e., in accordance with the paging cycle. Alternatively, the indication may instruct the second communication apparatus to keep the electronic components required for receiving transmissions enabled until the aperiodic small data transmission is terminated or completed.

In one or more embodiments the method in accordance with the first aspect further comprises deferring the transmission of aperiodic small data transmissions until an acknowledgement or confirmation of readiness has been received from the second communication apparatus.

The signal indicating properties of an impending small data transmission to the second communication apparatus may further comprise configuration information for the radio resources used in connection with the small data transmission. Accordingly, in one or more embodiments the method in accordance with the first aspect further comprises transmitting, in the signal indicating properties of the impending small data transmission, configuration information for the radio resources used in connection with the small data transmission.

In accordance with a second aspect of the invention a first communication apparatus of a radio access network comprises one or more microprocessors, volatile and non-volatile memory, and wireless receiver and transmitter means. The aforementioned components are communicatively connected via at least one data connection or bus. The non-volatile memory comprises computer program instructions which, when executed by the one or more microprocessors control the wireless receiver and transmitter means to establish, maintain and terminate communication connections with one or more second communication apparatus in accordance with a fourth aspect of the invention. The non-volatile memory further stores computer program instructions which, when executed by the one or more microprocessors, configure the first communication apparatus to implement and execute the method or embodiments thereof in accordance with the first aspect of the invention.

In accordance with a third aspect of the invention a method of operating a second communication apparatus for receiving aperiodic small data transmission from a first communication apparatus while the second communication apparatus is in a first operating mode. In the first operating mode electronic components necessary for receiving transmissions are periodically enabled for brief time periods and disabled in between, in accordance with a schedule, scheme, or paging cycle that is configured in accordance with information received from the first communication apparatus. The method in accordance with the third aspect comprises receiving a paging message to the second communication apparatus in accordance with the paging cycle. The paging message includes or is complemented by a signal indicating properties of an impending small data transmission to the second communication apparatus.

The properties may comprise, inter alia, an indication if the impending small data transmission is transmitted in periodic intervals, i.e., in accordance with a periodic traffic pattern, or aperiodically, i.e., not following a periodic traffic pattern. A periodic or aperiodic small data transmission may be indicated by a corresponding bit's value transmitted in connection with a paging message. Accordingly, the method further comprises determining, if the properties in the received signal indicate that the impending small data transmission follows a periodic pattern or is aperiodic. If an aperiodic small data transmission is indicated, the method further comprises determining, from the received signal indicating properties of the impending small data transmission, in a small data transmission, or on a separate control channel, an indication permitting detection of a completion or termination of the small data transmission.

The signal indicating properties of an impending small data transmission to the second communication apparatus, or an aperiodic small data transmission itself, may further comprise an indication of a time at which the next aperiodic small data transmission will be sent. The time may be indicated, e.g., by a timer value for the second communication apparatus, at which the second communication apparatus is expected to have the electronic components required for receiving transmissions enabled, or that the next aperiodic small data transmission will be transmitted at the occasion of the next enabling of the electronic components required for receiving transmissions, as scheduled in the second communication apparatus, i.e., in accordance with the paging cycle. Alternatively, the indication may instruct the second communication apparatus to keep the electronic components required for receiving transmissions enabled until the aperiodic small data transmission is terminated or completed. The time at which the next segment of the transmission will be transmitted may be indicated by means of a timer value transmitted along with each small data transmission. The method further comprises determining, from the signal indicating properties of the impending small data transmission or in a small signal transmission, a time at which the next aperiodic small data transmission will be sent. The electronic components necessary for receiving transmissions are enabled in accordance with the determined time.

The times at which the electronic components of the second communication apparatus necessary for receiving transmissions are enabled and disabled, respectively, in accordance with the first operating state, e.g., the times defined in the paging cycle, need not be modified. Rather, the electronic components of the second communication apparatus necessary for receiving transmissions are additionally enabled irrespective of a scheduled activation or inactivation stipulated for the first operating mode, in accordance with the time determined from the received signal and while the small data transmission is not completed. This enables the first communication apparatus to receive transmissions in between the occasions in which the electronic components necessary for receiving transmissions are enabled according to the paging cycles, without fully connecting to the first communication apparatus.

The second communication apparatus may continue the scheduled activation or inactivation of the electronic components necessary for receiving transmissions in accordance with the paging cycle throughout and beyond the transmission of the small data transmission.

In one or more embodiments the method in accordance with the third aspect of the invention further comprises, if a time at which the next aperiodic small data transmission will be sent is received, determining, from the received signal indicating properties, a time value validity information. The electronic components necessary for receiving a small data transmission from the first communication apparatus are enabled or disabled in accordance with the determined time and the timer value validity information.

It is assumed, for example, that the second communication apparatus will disable the electronic components necessary for receiving a small data transmission from the first communication apparatus until the time expires.

If the timer has a non-zero value and the timer value validity information indicates validity of the timer value, the electronic components necessary for receiving a small data transmission to the first communication apparatus may be disabled until the time expires. If the time of expiry falls into a time period of the paging cycle, at which the electronic components necessary for receiving a small data transmission from the first communication apparatus are disabled, the electronic components necessary for receiving a small data transmission from the first communication apparatus are enabled after expire of the time, for receiving small data transmission. If the time of expiry falls into a time period of the paging cycle, at which the electronic components necessary for receiving a small data transmission from the first communication apparatus are enabled, small data transmission may be received during this time period.

If the timer value validity information indicates that the timer value is valid, and a timer value is zero, the second communication apparatus may default to enabling the electronic components required for receiving transmissions in accordance with the regular paging cycle.

If the timer value validity information indicates that the timer value is invalid the second communication apparatus may enable the electronic components required for receiving transmissions until the small data transmission is completed or terminated.

In one or more embodiments the method in accordance with the third aspect of the invention further comprises, if a periodic traffic pattern for the small data transmission is indicated, determining, from the received signal indicating properties, configuration information for the radio resources used in connection with the small data transmission. The configuration information may relate, e.g., to dedicated and/or shared configured grant (CG) radio resources.

In one or more embodiments the method in accordance with the third aspect of the invention further comprises, if a periodic traffic pattern for the small data transmission is indicated, transmitting a signal indicating acknowledgement or confirmation of readiness for the reception of aperiodic small data transmission in accordance with the received properties.

In accordance with a fourth aspect of the invention a second communication apparatus of a radio access network comprises one or more microprocessors, volatile and non-volatile memory, and wireless receiver and transmitter means. The aforementioned components are communicatively connected via at least one data connection or bus. The non-volatile memory comprises computer program instructions which, when executed by the one or more microprocessors control the wireless receiver and transmitter means to establish, maintain and terminate communication connections with a first communication apparatus in accordance with the second aspect of the invention. The non-volatile memory further stores computer program instructions which, when executed by the one or more microprocessors, configure the second communication apparatus to implement and execute the method or embodiments thereof in accordance with the third aspect of the invention.

Using transmitted information about properties of an impending series of small data transmissions, as proposed by the present invention, advantageously permits the UE to know whether or not, and when and for how long, it has to enable the electronic components required for receiving further transmissions in connection with a small data transmission. The invention may be used to great advantage in radio-connected sensors, IoT devices, and generally all radio-connected devices running on battery power. The electronic components of the UE may be disabled at any time when they need not be enabled in accordance with the paging cycle or the indicated next small data transmission.

Transmitting small amounts of DL data without going from an RRC_INACTIVE operating mode to an RRC_CONNECTED operating mode not only reduces the energy consumption, but also results in a reduced signalling overhead, freeing resources for other tasks in the RAN.

The electronic components controlled by executing the methods described hereinbefore may be part of or form a receiver including, inter alia, a radio frequency modem, a baseband receiver, and the like. This may help maintaining a low energy consumption in the UE, while being capable of receiving the entire transmission.

While the invention has been described with a focus on a radio access network in accordance with the 3GPP TS 38.300 standard family, also referred to as 5G NR, it may also be used in further developments thereof, e.g., the future 6G standard. Also, while the invention has been described with a focus on the RRC_INACTIVE operating mode, it is not limited thereto, but may be used in all wireless systems in which UEs need to connect to network infrastructure for data transmission and reception and disable a receiver when not actively communicating, and which provide a mechanism via which small amounts of data can be transmitted without fully connecting to the network infrastructure.

The methods described hereinbefore may be represented by computer program instructions which, when executed by a microprocessor, cause the computer and/or control hardware components of a first communication apparatus in accordance with the second aspect of the invention, or of a second communication apparatus in accordance with fourth aspect of the invention, respectively, to execute methods in accordance the first or the third aspect of the invention, respectively.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

The second communication apparatus may be a mobile device including, but not limited to a mobile phone, a tablet computer, or a motor vehicle, but may also be a stationary device, including, but not limited to a wireless-enabled IoT device, a road side unit and the like.

### BRIEF DESCRIPTION OF THE DRAWINGS

In the following section the invention will be described with reference to the figures. The examples provided in the figures are illustrative only, and should not be considered limiting the scope of the claims.

FIG. 1 shows a simplified schematic flow diagram of a known method of mobile-originated small data transmission.

FIG. 2 shows a simplified schematic flow diagram of a known method of mobile-terminated data transmission.

FIG. 3 shows a simplified schematic flow diagram of a method of mobile-terminated data transmission in accordance with the present invention.

FIG. 4 shows a simplified schematic flow diagram of a method in accordance with the invention executed in a first communication apparatus.

FIG. 5 shows a simplified schematic flow diagram of a method in accordance with the invention executed in a second communication apparatus.

FIG. 6 shows a schematic block diagram of a first or second communication apparatus.

In the figures identical or similar elements may be referenced using the same reference designators.

### DETAILED DESCRIPTION

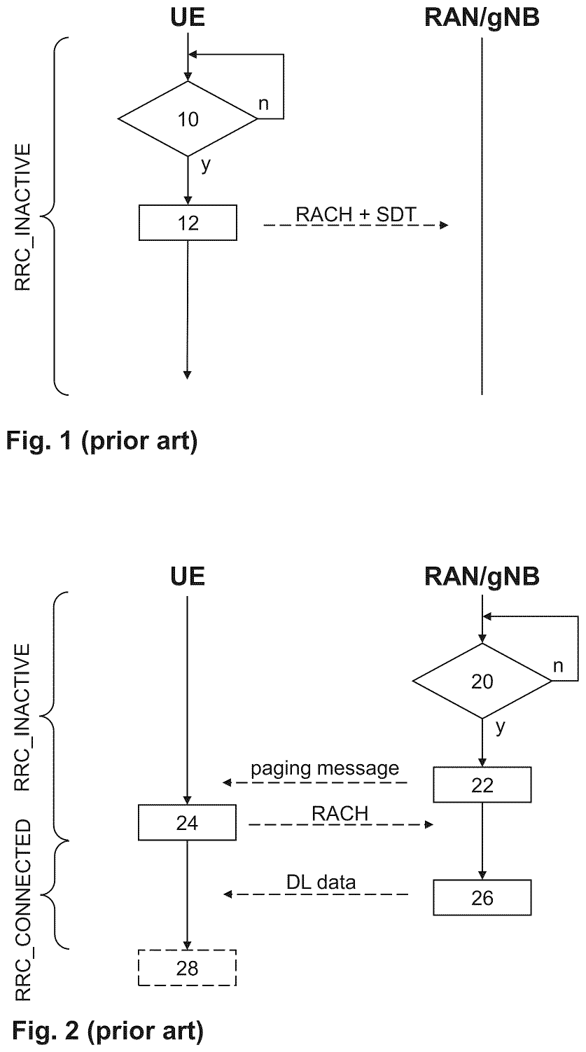

FIGS. 1 and 2 have been discussed further above with regard to the prior art and will not be discussed again.

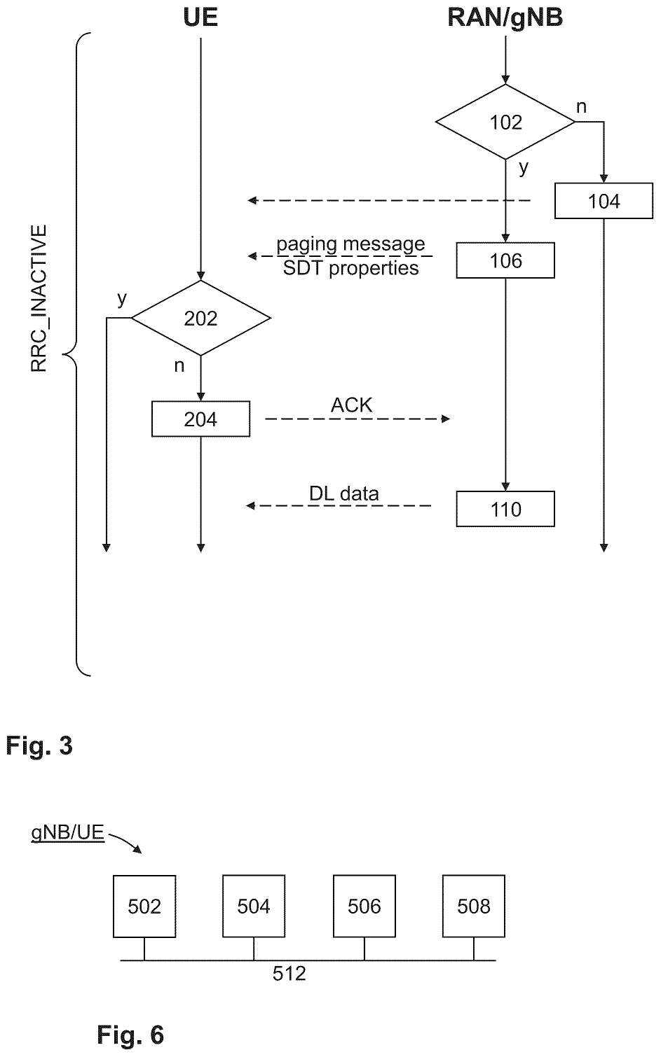

FIG. 3 shows a simplified schematic flow diagram of a method of mobile-terminated data transmission in accordance with the present invention. In step 102 the RAN/gNB determines if an SDT to the UE is to be initiated. In the negative case, “no”-branch of step 102, a regular paging message, i.e., a paging message that does not carry or convey properties of an impending SDT, is sent to the UE in step 104, and the method is repeated in accordance with the paging cycle. In the positive case, “yes”-branch of step 102, a paging message with properties of an impending SDT is sent to the UE in step 106. In step 202 the UE determines if the received paging message is a regular one. In the positive case, “yes”-branch of step 202, the UE reacts to the paging message in the commonly known way. In the negative case, i.e., the paging message additionally carries properties of an impending SDT, “no”-branch of step 202, the UE, in step 204, acknowledges the impending SDT and enables the electronic components required for receiving transmissions in accordance with the properties received in connection with the paging message. In step 110 the gNB transmits the small data accordingly.

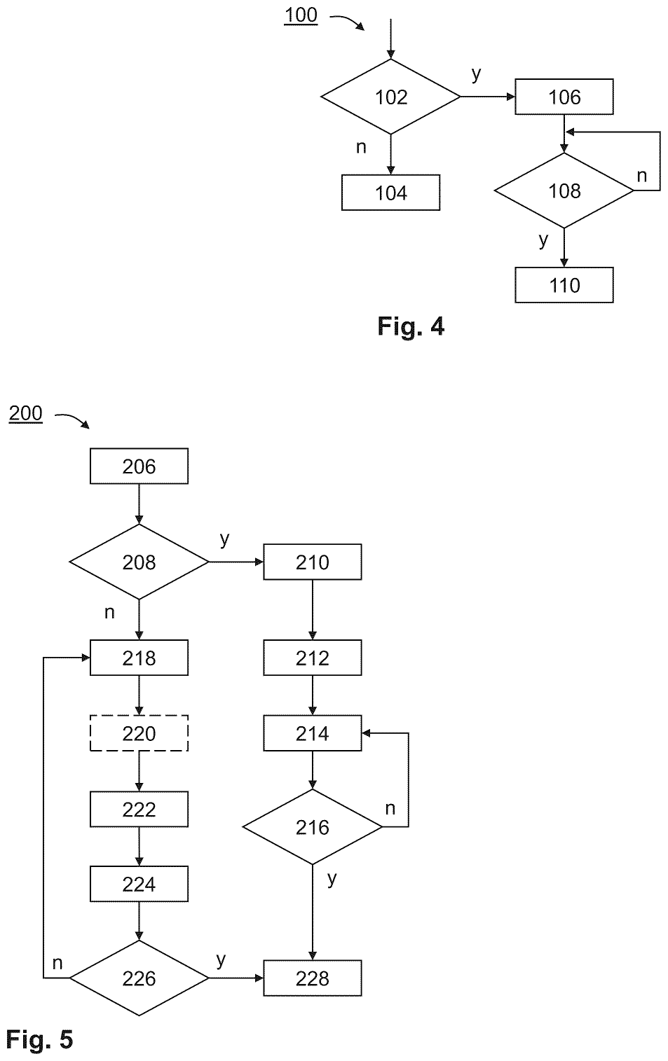

FIG. 4 shows a simplified schematic flow diagram of a method 100 in accordance with the first aspect of the invention executed in a first communication apparatus gNB. In step 102 the first communication apparatus gNB determines, if a small data transmission is to be sent to the second communication apparatus UE. In the negative case, “no”-branch of step 102, the first communication apparatus gNB sends, in step 104, a regular paging message in accordance with the paging cycle of the second communication apparatus UE. In the positive case, “yes”-branch of step 102, the first communication apparatus gNB sends, in step 106, a paging message with properties of an impending SDT to the second communication apparatus UE. The first communication apparatus gNB waits, step 108, for a confirmation from the second communication apparatus UE, and once the confirmation is received, the first communication apparatus gNB transmits, in step 110, the small data transmission in accordance with the properties transmitted in step 106.

FIG. 5 shows a simplified schematic flow diagram of a method 200 in accordance with the third aspect of the invention executed in a second communication apparatus UE. In step 206 the UE receives, from a first communication apparatus gNB, a signal indicating properties of an impending small data transmission to the second communication apparatus UE. In step 208 the second communication apparatus determines from the received properties, if the impending small data transmission is periodic.

In the positive case, “yes”-branch of step 208, the second communication apparatus determines, in step 210, at least the periodicity of the impending small data transmission's traffic pattern, and configures enabling, in step 212, the electronic components required for receiving transmissions from the first communication apparatus in accordance with the periodicity received in the signal indicating properties of the impending small data transmission. In step 214 the second communication apparatus UE receives the small data transmission at the configured times. Completion or termination of the small data transmission is checked in step 216. When the small data transmission is completed or terminated, “yes”-branch of step 216, the second communication apparatus UE configures enabling, in step 228, the electronic components required for receiving transmissions from the first communication apparatus in accordance with the original paging cycle. Otherwise, “no”-branch of step 216, the next small data transmission is received in step 214.

If the impending small data transmission is not periodic, “no”-branch of step 208, the second communication apparatus UE determines, in step 218, a time when the electronic components required for receiving transmissions need to be enabled for receiving the next small data transmission and, optionally, in step 220, configures the radio resources, based on the received properties. The time for enabling the electronic components required for receiving transmissions may be indicated, e.g., using a timer value validity information and a timer value. The timer value validity information may be represented in one bit transmitted in the signal indicating properties of an impending small data transmission to the second communication apparatus UE, e.g., the paging message to the UE.

If the timer value validity information indicates that the timer value is valid a corresponding timer value determining for how long the electronic components required for receiving transmissions may be disabled may be received in a separate control channel. In 3GPP 5G the separate control channel may be the physical downlink control channel PDCCH. Using a separate control channel for transmitting the timer value may save energy in the second communication apparatus.

If the timer value validity information indicates that the timer value is valid, and a timer value is zero (0), the second communication apparatus may default to enabling the electronic components required for receiving transmissions in accordance with the regular paging cycle. This may also be used for configuring the second communication apparatus after the small data transmission is completed or terminated, in step 228.

If the timer value validity information indicates that the timer value is invalid the second communication apparatus enables the electronic components required for receiving transmissions until the small data transmission is completed or terminated.

In step 222, the electronic components required for receiving transmissions from the first communication apparatus while the small data transmission is not completed or terminated are enabled in accordance with the received properties and/or further received information, for receiving, in step 224, the small data transmission. Completion or termination of the small data transmission is checked in step 226. When the small data transmission is completed or terminated, “yes”-branch of step 226, the second communication apparatus UE configures enabling, in step 228, the electronic components required for receiving transmissions from the first communication apparatus in accordance with the original paging cycle.

FIG. 6 shows a schematic block diagram of a first or second communication apparatus in accordance with the second and fourth aspect of the invention, respectively. The first and second communication apparatus gNB, UE, of a radio access network comprise one or more microprocessors 502, volatile and non-volatile memory 504, 506, and wireless receiver and transmitter means 508, which are communicatively connected via at least one data connection or bus 512. The non-volatile memory 506 comprises computer program instructions which, when executed by the one or more microprocessors 502 control the wireless receiver and transmitter means 508 to establish, maintain and terminate communication connections between the first and the second communication apparatus, wherein the non-volatile memory 506 further stores computer program instructions which, when executed by the one or more microprocessors 502, configure the first and the second communication apparatus gNB, UE, respectively to implement and execute the method in accordance with the first or the third aspect of the invention.

LIST OF REFERENCE NUMERALS
(PART OF THE DESCRIPTION)

| | |
|---|---|
| 10 | UL data to send? |
| 12 | perform RACH procedure + |
| | transmit small data |
| 20 | DL data to send? |
| 22 | paging message |
| 24 | perform RACH procedure and go |
| | to RRC_CONNECTED |
| 26 | transmit DL data |
| 28 | go to RRC_INACTIVE |
| 100 | method (gNB) |
| 102 | DL data to send? |
| 104 | paging message |
| 106 | paging message + SDT properties |
| 108 | wait for confirmation |
| 110 | transmit SDT |
| 200 | method (UE) |
| 202 | regular paging message? |
| 204 | acknowledge + adjust enabling |
| | receiver |
| 206 | receive signal indicating |
| | properties of traffic pattern of |
| | impending SDT |
| 208 | periodic SDT? |
| 210 | determine at least periodicity of |
| | impending SDT |
| 212 | configure enabling receiver for |
| | periodic enabling |
| 214 | receive SDT |
| 216 | transmission |
| | completed/terminated? |
| 218 | determine time of next SDT |
| 220 | configure radio resource |
| 222 | enable receiver |
| 224 | receive SDT |
| 226 | transmission |
| | completed/terminated? |
| 228 | configure receiver for paging |
| | cycle |
| gNB | first communication apparatus |
| UE | second communication apparatus |

1. A method of operating a first communication apparatus for configuring a second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, the method comprising:
transmitting a paging message to the second communication apparatus, wherein the paging message includes or is complemented by a signal indicating properties of an impending small data transmission to the second communication apparatus.

2. The method of claim 1, wherein the signal indicating properties of an impending small data transmission to the second communication apparatus comprises an indication whether a periodic or an aperiodic small data transmission is impending, further comprising, if an aperiodic small data transmission is impending:
transmitting, in the signal indicating properties of the impending small data transmission, in a small signal transmission, or on a separate control channel, an indication permitting detection of a completion or termination of the small data transmission.

3. The method of claim 1, wherein the signal indicating properties of an impending small data transmission to the second communication apparatus comprises an indication whether a periodic or an aperiodic small data transmission is impending, further comprising, if an aperiodic small data transmission is impending:
transmitting, in the signal indicating properties of the impending small data transmission or in a small data transmission, an indication of a time at which the next aperiodic small data transmission will be sent.

4. The method claim 1, further comprising deferring the transmission of aperiodic small data transmissions until an acknowledgement or confirmation of readiness has been received from the second communication apparatus.

5. The method of claim 1, wherein the signal indicating properties of an impending small data transmission to the second communication apparatus comprises an indication whether a periodic or an aperiodic small data transmission is impending, further comprising, if an aperiodic small data transmission is impending:
transmitting, in the signal indicating properties of the impending small data transmission configuration, information for the radio resources used in connection with the small data transmission.

6. A method of operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, the method comprising:
receiving, from the first communication apparatus and during a time period of the paging cycle, in which the electronic components necessary for receiving transmissions are enabled, a signal indicating properties of an impending small data transmission to the second communication apparatus.

7. The method of claim 6, further comprising:
determining whether the properties in the received signal indicate an impending aperiodic small data transmission to the second communication apparatus, and if an aperiodic small data transmission is indicated:
determining, from the signal indicating properties of the impending small data transmission, in a small signal transmission, or on a separate control channel, an indication permitting detection of a completion or termination of the small data transmission.

8. The method of claim 6, further comprising:
determining whether the properties in the received signal indicate an impending aperiodic small data transmission to the second communication apparatus, and if an aperiodic small data transmission is indicated:
determining, from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time.

9. The method of claim 8, further comprising:
determining, from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information.

10. The method claim 6, further comprising:
determining whether the properties in the received signal indicate an impending aperiodic small data transmission to the second communication apparatus, and if an aperiodic small data transmission is indicated:
determining, from the signal indicating properties of the impending small data transmission, configuration information for the radio resources used in connection with the small data transmission.

11. The method claim 6, further comprising:
determining whether the properties in the received signal indicate an impending aperiodic small data transmission to the second communication apparatus, and if an aperiodic small data transmission is indicated:
transmitting a signal indicating acknowledgement or confirmation of readiness for the reception of aperiodic small data transmission in accordance with the received properties.

12. A first communication apparatus of a radio access network comprising one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus wherein the paging message includes or is complemented by a signal indicating properties of an impending small data transmission to the second communication apparatus;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule scheme or paging cycle that is configured in accordance with information received from the first communication apparatus by:
transmitting a paging message to the second communication apparatus wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprises: if an aperiodic small data transmission is impending:
transmitting, in the signal indicating properties of the impending small data transmission, in a small signal transmission, or on a separate control channel, an indication permitting detection of a completion or termination of the small data transmission;
operating the first communication apparatus for configuring the second communication apparatus to receive aperiodic small data transmission while the second communication apparatus is in a first operating mode in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending, further comprises, if an aperiodic small data transmission is impending:
transmitting in the signal indicating properties of the impending small data transmission or in a small data transmission, an indication of a time at which the next aperiodic small data transmission will be sent;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus; and
deferring the transmission of aperiodic small data transmissions until an acknowledgement or confirmation of readiness has been received from the second communication apparatus; and
operating the first communication apparatus for configuring the second communication apparatus to receive aperiodic small data transmission while the second communication apparatus is in a first operating mode in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprising, if an aperiodic small data transmission is impending:
transmitting in the signal indicating properties of the impending small data transmission configuration, information for the radio resources used in connection with the small data transmission:
wherein the one or more second communication apparatus comprises:
one of:
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining, from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle, in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining, from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining, from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle, in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining, from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
wherein the one or more second communication apparatus is configured to establish, maintain, and terminate a wireless communication connection in accordance with 3GPP 5G and/or 6G standards.

13. The first communication apparatus of claim 12, further characterized by being configured to establish, maintain, and terminate a wireless communication connection in accordance with 3GPP 5G and/or 6G standards.

14. A second communication apparatus comprising one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain and terminate communication connections with a first communication apparatus of a radio access network, wherein the non-volatile memory further stores computer program instructions which, when executed by the one or more microprocessors, configure the second communication apparatus to implement and perform operations comprising:
one of:
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus;
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
control channel, a time at which the next aperiodic small data transmission will be sent, and
enabling the electronic components necessary for receiving a small data transmission to the second communication apparatus in accordance with the determined time;
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled a signal indicating properties of an impending small data transmission to the second communication apparatus:
determining from the signal indicating properties of the impending small data transmission or in a small signal transmission or on a separate control channel, a timer value validity information, and
enabling the electronic components necessary for receiving a small data transmission to the second communication apparatus in accordance with the determined time and the timer value validity information;
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle in which the electronic components necessary for receiving transmissions are enabled, a signal indicating properties of an impending small data transmission to the second communication apparatus;
determining whether the properties in the received signal indicate an impending aperiodic small data transmission to the second communication apparatus, and
if an aperiodic small data transmission is indicated:
determining, from the signal indicating properties of the impending small data transmission, configuration information for the radio resources used in connection with the small data transmission; and
operating a second communication apparatus for receiving aperiodic segmented small data transmission from a first communication apparatus, while the second communication apparatus is in a first operating mode, in which electronic components necessary for receiving transmissions are periodically enabled for brief time periods and disabled in between enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
wherein the first communication apparatus of a radio access network comprises one of:
one or more microprocessors, volatile and non-volatile memory, and wireless receiver and transmitter, which are communicatively connected via at least one data connection or bus wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus:
operating the first communication apparatus for configuring the second communication apparatus to receive aperiodic small data transmission while the second communication apparatus is in a first operating mode in which electronic components necessary for receiving transmissions are periodically enabled for brief time periods and disabled in between, enabling and disabling being in accordance with a schedule, scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending, further comprises: if an aperiodic small data transmission is impending:
transmitting in the signal indicating properties of the impending small data transmission, in a small signal transmission, or on a separate control channel, an indication permitting detection of a completion or termination of the small data transmission;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprises, if an aperiodic small data transmission is impending:
transmitting in the signal indicating properties of the impending small data transmission or in a small data transmission, an indication of a time at which the next aperiodic small data transmission will be sent;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus, and
deferring the transmission of aperiodic small data transmissions until an acknowledgement or confirmation of readiness has been received from the second communication apparatus; and
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending, further comprising, if an aperiodic small data transmission is impending;
transmitting, in the signal indicating properties of the impending small data transmission configuration, information for the radio resources used in connection with the small data transmission;
wherein the one or more second communication apparatus comprises:
one of:
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode in which enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving, from the first communication apparatus and during a time period of the paging cycle, in which the electronic components necessary for receiving transmissions are enabled, a signal indicating properties of an impending small data transmission to the second communication apparatus:
determining, from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
determining from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
wherein the one or more second communication apparatus is configured to establish, maintain, and terminate a wireless communication connection in accordance with 3GPP 5G and/or 6G standards; and
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
operating the first communication apparatus for configuring the second communication apparatus to receive aperiodic small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprises: if an aperiodic small data transmission is impending:
transmitting, in the signal indicating properties of the impending small data transmission, in a small signal transmission, or on a separate control channel, an indication permitting detection of a completion or termination of the small data transmission;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprises, if an aperiodic small data transmission is impending:
transmitting in the signal indicating properties of the impending small data transmission or in a small data transmission, an indication of a time at which the next aperiodic small data transmission will be sent;
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule scheme or paging cycle that is configured in accordance with information received from the first communication apparatus by:
transmitting a paging message to the second communication apparatus, wherein the paging message includes or is complemented by a signal indicating properties of an impending small data transmission to the second communication apparatus; and
deferring the transmission of aperiodic small data transmissions until an acknowledgement or confirmation of readiness has been received from the second communication apparatus; and
operating the first communication apparatus for configuring the second communication apparatus to receive aperiodic small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by:
transmitting a paging message to the second communication apparatus, wherein the paging message includes or is complemented by a signal indicating properties of an impending small data transmission to the second communication apparatus;
wherein the signal indicating properties of an impending small data transmission to the second communication apparatus comprises an indication whether a periodic or an aperiodic small data transmission is impending further comprising, if an aperiodic small data transmission is impending:
transmitting, in the signal indicating properties of the impending small data transmission configuration, information for the radio resources used in connection with the small data transmission;
wherein the one or more second communication apparatus comprises:
one of:
one or more microprocessors, volatile and non-volatile memory, and wireless receiver and transmitter which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus;
determining, from the signal indicating properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining, from the signal indicating properties of the impending small data transmission, in a small signal transmission, or on a separate control channel, an indication permitting detection of a completion or termination of the small data transmission;
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission or in a small signal transmission, or on a separate control channel, a time at which the next aperiodic small data transmission will be sent, and
enabling the electronic components necessary for receiving a small data transmission to the second communication apparatus in accordance with the determined time;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle, in which the electronic components necessary for receiving transmissions are enabled, a signal indicating properties of an impending small data transmission to the second communication apparatus:
determining, from the signal indicting properties of the impending small data transmission or in a small signal transmission, or on a separate control channel, a timer value validity information, and
enabling the electronic components necessary for receiving a small data transmission to the second communication apparatus in accordance with the determined time and the timer value validity information;
operating the one or more second communication apparatus for receiving aperiodic segmented small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
determining from the signal indicating properties of the impending small data transmission, configuration information for the radio resources used in connection with the small data transmission; and
operating the one or more second communication apparatus for receiving aperiodic segmented small data transmission from a first communication apparatus, while the second communication apparatus is in a first operating mode, in which enabled for brief time periods and disabled in between, enabling and disabling being in accordance with a paging cycle configured in accordance with information received from the first communication apparatus by:
receiving from the first communication apparatus and during a time period of the paging cycle in which the electronic components necessary for receiving transmissions are enabled, a signal indicating properties of an impending small data transmission to the second communication apparatus:
determining whether the properties in the received signal indicate an impending aperiodic small data transmission to the second communication apparatus, and
if an aperiodic small data transmission is indicated:
transmitting a signal indicating acknowledgement or confirmation of readiness for the reception of aperiodic small data transmission in accordance with the received properties; and
wherein the one or more second communication apparatus is configured to establish, maintain, and terminate a wireless communication connection in accordance with 3GPP 5G and/or 6G standards; and
wherein the first communication apparatus is further configured to establish, maintain, and terminate a wireless communication connection in accordance with 3GPP 5G and/or 6G standards.

15. The second communication apparatus of claim 14, further characterized by being configured to establish, maintain, and terminate a wireless communication connection in accordance with 3GPP 5G and/or 6G standards.

16. (canceled)

17. (canceled)

18. (canceled)
